(19) United States
(12) Patent Application Publication
(10) Pub. No.: US 2018/0298686 A1
(43) Pub. Date: Oct. 18, 2018

(54) SCREEN TO PROTECT OPENING OF AN ESTABLISHMENT

(71) Applicant: Daniel Hearne, Ipswich (GB)

(72) Inventor: Daniel Hearne, Ipswich (GB)

(21) Appl. No.: 15/489,902

(22) Filed: Apr. 18, 2017

(51) Int. Cl. E06B 9/52

(52) U.S. Cl. CPC E06B 9/52; E06B 2009/524

(57) ABSTRACT

Disclosed is a screen to protect one or more opening of an establishment. The screen includes a pair of sheet. The pair of sheet includes an outer body, and an inner body. In an embodiment, the outer body includes plurality of external portions, and plurality of inner portions. The external portions are in contact with the opening of the establishment. The inner portions are detachably attached with each other through an attachment means. The inner body has a pre-defined structure and made of a non-metallic material.

### TECHNICAL FIELD

The presently disclosed embodiments are related, in general, to a protective screen for door and windows of an establishment. More particularly, the presently disclosed embodiments are related to material of the screen to protect one or more openings of an establishment.

### BACKGROUND

Traditionally, screens or curtains are used at the openings of the establishment such as door/window of the industrial, commercial, medical and residential premises. These screens or curtains protect the people residing inside the establishment from the insects and further provides ventilation. However, these screens are made of nylon. However, nylon is not fire resistant and life of the screens made of nylon is very short. Further these aforementioned screens are prone to be chewed or scratched by the pet animals.

Therefore, there is a need of a fire-resistant screen that protects opening of the establishment. Further there is also a need of a screen that allows air to pass through and stops the insects to enter into establishment. Furthermore, there is also a need of a screen which is made of a non-metallic material to increase the longevity of the screen.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a screen to protect one or more opening of an establishment. The screen includes a pair of sheet. The pair of sheet includes an outer body, and an inner body. In an embodiment, the outer body includes plurality of external portions, and plurality of inner portions. The external portions are in contact with the opening of the establishment. The inner portions are detachably attached with each other through an attachment means. The inner body has a pre-defined structure and made of a non-metallic material.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a screen to protect one or more opening of an establishment, in accordance with a preferred embodiment of the invention; and

FIG. 2 illustrates an environmental diagram of the screen to protect the opening of the establishment, in accordance with a preferred embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only. Those skilled in the art will envision many other possible variations within the scope of the technology described herein.

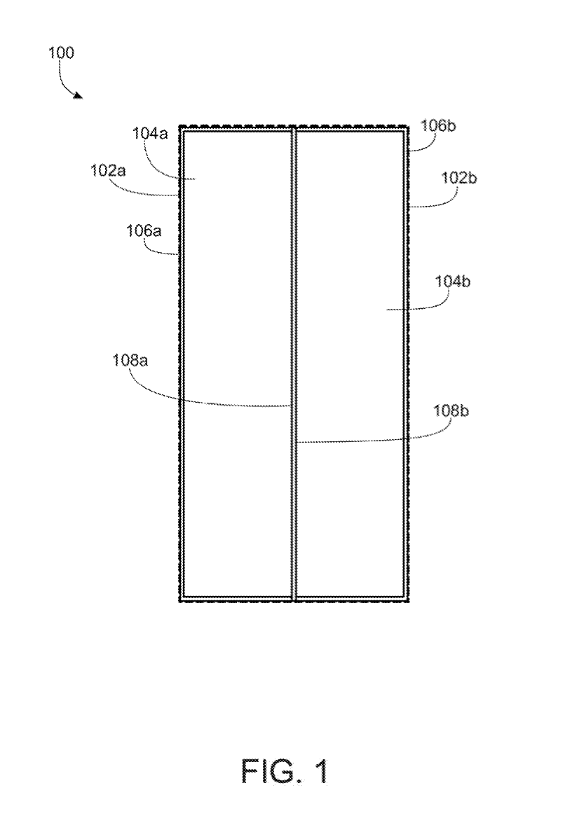

FIG. 1 illustrates a screen 100 to protect one or more opening of an establishment, in accordance with a preferred embodiment of the invention. The screen includes a pair of sheet 102a and 102b. The pair of sheet 102a, and 102b includes an outer body (shown as dotted lines) and an inner body 104a, 104b. In an embodiment, the outer body includes plurality of external portions 106a, 106b and plurality of inner portions 108a, 108b. In an embodiment, the first external portion 106a is a part of the sheet 102a and the second external portion 106b is part of the sheet 102b. The external portions 106a, 106b are in contact with the opening of the establishment. The opening of the establishment includes but not limited to a door, a window etc.

The inner portions 108a, 108b are detachably attached with each other through an attachment means. Examples of the attachment means include but not limited to a magnet, a mechanical based fastener such as VELCRO from the Velcro Industries B.V. The inner body 104a, 104b has a pre-defined structure and made of a non-metallic material. The first inner body 104a is part of the sheet 102a and the second inner body 104b is part of the sheet 102b.

In an embodiment, the non-metallic material is fiberglass. The utilization of the fiberglass makes the inner body 104a, and 104b increases the longevity of the screen 100. Additionally, the fiberglass is fire resistant. The fiberglass is fiber-reinforced plastic where the reinforcement fiber is specifically glass fiber. The glass fiber randomly arranged, flattened into a sheet, or woven into a fabric. The fiber glass increase the tensile strength and thermal stability of the screen 100. Further the pre-defined structure of the inner body 104a, and 104b is interwoven structure like a mesh which allows the air to pass through without interference and does not allow insects to enter the establishment.

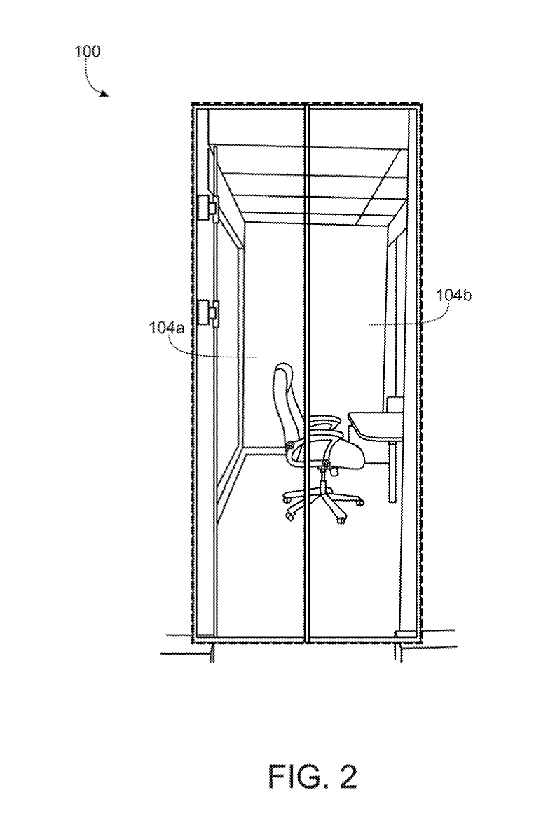

FIG. 2 illustrates an environmental diagram of the screen 100 to protect the opening of the establishment, in accordance with a preferred embodiment of the invention. FIG. 2 is explained in conjunction with FIG. 1. Example of the establishment includes but not limited to office, house, commercial or residential places. The inner body 104a, 104b corresponding to the sheet 102a, 102b is of interwoven structure so that the air pass through and make the environment airy. Further the utilization of fiberglass makes the screen transparent so that a user can see through the other side of the screen 100. Additionally, the fiberglass makes the screen 100 resistant to chewing, scratching and making rips by the pets.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A screen to protect one or more opening of an establishment, the screen comprising:
a pair of sheet includes an outer body, and an inner body, wherein the outer body includes plurality of external portions, and plurality of inner portions, the external portions are in contact with the opening of the establishment, and the inner portions are detachably attached with each other through an attachment means, further the inner body has a pre-defined structure and made of a non-metallic material.

2. The screen according to claim 1 wherein the non-metallic material is fiberglass.

3. The screen according to claim 1 wherein the attachment means include at least one of: a magnet, a mechanical based fastener, and/or combination thereof.

4. The screen according to claim 1 wherein the opening of the establishment is a door, a window, and/or combination thereof.

5. The screen according to claim 1 wherein the pre-defined structure of the inner body is interwoven structure.
